(19) United States
(12) Patent Application Publication
(10) Pub. No.: US 2017/0100883 A1
(43) Pub. Date: Apr. 13, 2017

(54) METHOD AND APPARATUS FOR A MEMBRANE APPLICATOR

(71) Applicant: JST Performance, LLC, Gilbert, AZ (US)

(72) Inventor: Jacob R Majerczyk, Scottsdale, AZ (US)

(21) Appl. No.: 14/881,295

(22) Filed: Oct. 13, 2015

(51) Int. Cl. B29C 65/48; F21V 31/00; F21V 31/03

(52) U.S. Cl. CPC B29C 65/48; F21V 31/03; F21V 31/005; B29L 2031/747

(57) ABSTRACT

An applicator may comprise a housing, a shaft, and a biasing member. The shaft may be capable of telescoping movement within the housing between first and second positions. The biasing member may be disposed between the shaft and the housing and may exhibit a first length and a first force at the first position, and a second length and a second force at the second position. The applicator may be part of a membrane applicator system, which may further comprise a fixture, a membrane, a frame, and a suction device. The applicator may be configured to uniformly apply the membrane with the second force into coupling engagement over an aperture in the fixture. The suction device may be coupled to an outlet of the shaft and may cause fluid flow between an inlet of the shaft and the outlet to maintain the membrane in a coupling engagement with the applicator.

### FIELD OF THE INVENTION

The present invention generally relates to lighting systems, and more particularly to the application of membranes to lighting systems.

### BACKGROUND

Light emitting diodes (LEDs) have been utilized since about the 1960s. However, for the first few decades of use, the relatively low light output and narrow range of colored illumination limited the LED utilization role to specialized applications (e.g., indicator lamps). As light output improved, LED utilization within other lighting systems, such as within LED “EXIT” signs and LED traffic signals, began to increase. Over the last several years, the white light output capacity of LEDs has more than tripled, thereby allowing the LED to become the lighting solution of choice for a wide range of lighting solutions.

Lighting systems may include LEDs, a printed circuit board (PCB), and associated control circuitry and may be mounted within a fixture (e.g., light bar). Lighting systems may be used in adverse conditions (e.g., inclement weather). In order to protect the lighting systems, conventional lighting fixtures may be manufactured to be sealed from the environment so as to protect the PCB, LEDs and associated control circuitry contained within the lighting fixture. The fixture may be sealed using any of a various assortment of seals.

During operation LEDs may heat up and the heat may cause a buildup of pressure inside the fixture. Pressure buildup may, either immediately or over time, cause a failure in the seals. Failure of the seals may enable entrance of moisture and other contaminants into the interior of the fixture and may result in adverse performance of the lighting system.

To prevent pressure buildup within the fixture and a resulting failure of seals, an aperture (e.g., vent) may be disposed within the fixture to enable the pressure within the fixture to normalize as compared to the environment outside the fixture. The presence of the opening, however, provides opportunity for moisture and other contaminants to enter the fixture and adversely affect the LEDs, the PCB, and/or the associated control circuitry.

In order to prevent entrance of moisture and other contaminants an air-permeable, moisture-impermeable membrane (e.g., sticker) may be attached to the fixture so as to be disposed over the opening.

Misalignment, rippling, or other inadequate application of the membrane over the opening may result in increased failure rates. In addition, if an operator applies the membrane by hand, finger oils may adversely affect the membrane's permeability, reducing the membrane's ability to normalize pressure within the fixture.

Efforts continue, therefore, to develop application systems for applying the membrane to the fixture consistently while reducing the occurrence of the failure modes described above.

### SUMMARY

To overcome limitations in the prior art, and to overcome other limitations that will become apparent upon reading and understanding the present specification, various embodiments of the present invention disclose methods and apparatus for the application of membranes to LED-based lighting systems.

In accordance with one embodiment of the invention, an applicator comprises a housing, a shaft, and a biasing member. The shaft has a first end and a second end. The first end of the shaft is received within the housing at first and second positions. The second end of the shaft has an inlet in fluidic communication with an outlet located at a point along a length of the shaft. The biasing member is disposed between the first end of the shaft and the housing and exhibits a first length at the first position and a second length at the second position. The biasing member exerts a predetermined force on the second end of the shaft which has a magnitude in proportion to a difference between the first and second lengths.

In accordance with another embodiment of the invention, a membrane applicator system comprises a fixture, a membrane, and an applicator. The fixture has an aperture therein. The membrane is coupled to the fixture and covers the aperture. The applicator is configured to press the membrane against the fixture. The applicator further includes a housing, a shaft, and a biasing member. The shaft has a first end and a second end. The first end of the shaft is capable of telescoping movement with respect to the housing between first and second positions. The biasing member is disposed between the first end of the shaft and the housing. The biasing member is configured to exert a first force against the shaft at the first position and exert a second force against the shaft at the second position, wherein the second force is substantially uniformly applied around a circumference of the membrane.

In accordance with another embodiment of the invention, a method comprises positioning a membrane on a second end of a shaft of an applicator and pressing the applicator. The applicator is pressed until the second end of the shaft comes into coupling engagement with a fixture to place the membrane into contact with the fixture and cover an aperture on the fixture. In this position a first end of the shaft is in a first position relative to the applicator. The applicator is then pressed with an increasing amount of force until the first end of the shaft is placed in a second position relative to the applicator. In this position the shaft exerts a predetermined amount of force substantially uniformly against a circumference of the membrane.

In accordance with another embodiment of the invention, a membrane applicator system comprises a frame, a fixture, a membrane, an applicator, and a suction device. The fixture has an aperture therein and is removably coupled to the frame. The membrane is coupled to the fixture and covers the aperture. The applicator is configured to press the membrane against the fixture. The applicator further includes a housing, a shaft, and a biasing member. The housing is coupled to the frame. The shaft has a first end and a second end. The first end is received within the housing at first and second positions. The second end has an inlet. The shaft includes an outlet located at a point along a length of the shaft. The biasing member is disposed between the first end of the shaft and the housing. The biasing member is configured to exert a first force against the shaft at the first position and exert a second force against the shaft at the second position, wherein the second force is substantially uniformly applied around a circumference of the membrane. The suction device is coupled to the outlet and causes fluid flow between the inlet and the outlet. The fluid flow maintains a coupling between the membrane and the applicator.

In accordance with another embodiment of the invention, a method comprises engaging a suction device, moving an applicator, and pressing the applicator. Engaging the suction device induces fluidic communication through a second end of a shaft of the applicator. The fluidic communication positions a membrane on the second end of the shaft. Moving the applicator includes moving the applicator with respect to a frame. The applicator is pressed until the second end of the shaft comes into coupling engagement with a fixture to place the membrane into contact with the fixture and cover an aperture on the fixture. In this position a first end of the shaft is in a first position relative to the applicator. The applicator is then pressed with an increasing amount of force until the first end of the shaft is place in a second position relative to the applicator. In this position the shaft exerts a predetermined amount of force substantially uniformly against a circumference of the membrane.

### BRIEF DESCRIPTION OF THE DRAWINGS

Various aspects and advantages of the invention will become apparent upon review of the following detailed description and upon reference to the drawings in which:

FIG. 1 illustrates a perspective view of a fixture with a membrane coupled thereto;

FIG. 2 illustrates a cross-sectional view of the fixture through a central axis of the aperture having the membrane covering the aperture at the base of a recess;

FIG. 3 illustrates a cross-sectional view of the fixture through a central axis of the aperture wherein a recess has an angled surface at the base;

FIG. 4 illustrates a plan view of a membrane for use with the present invention;

FIG. 5A illustrates a cross sectional view of an applicator according to the present invention;

FIG. 5B illustrates a cross sectional view of the applicator applying a membrane to a surface of a fixture;

FIG. 6A illustrates a cross sectional view of an applicator with pneumatic capabilities and a membrane dispensed below the applicator;

FIG. 6B illustrates a cross sectional view of the applicator showing a membrane partially peeled from a dispensable material;

FIG. 6C illustrates a cross sectional view of the applicator showing a membrane fully peeled from the dispensable material;

FIG. 6D illustrates a cross sectional view of the applicator showing the membrane pressed against a surface of a fixture;

FIG. 6E illustrates a cross sectional view of the applicator removed from contact with the membrane and the surface of the fixture;

FIG. 7 illustrates an automated applicator system with the applicator integrated into the system;

FIG. 8A illustrates a frame holding a first fixture;

FIG. 8B illustrates the frame holding a second fixture;

FIG. 9 illustrates a process of applying the membrane to a fixture; and

FIG. 10 illustrates a process of dispensing the membrane onto the applicator and positioning the applicator for the process of FIG. 9.

### DETAILED DESCRIPTION

Generally, the various embodiments of the present invention are applied to an apparatus for and/or a method of applying membranes (e.g., air-permeable, moisture-impermeable, pressure equalization membranes) to fixtures (e.g., lighting fixtures). A fixture may be presented which includes a compartment with an interior cavity which is substantially sealed. A light emitting diode (LED), a printed circuit board (PCB), and associated circuitry may be contained within the interior cavity to prevent moisture and other contaminants from entering and adversely affecting the LED, PCB, and associated circuitry.

The fixture may further include an aperture, which may extend entirely through a wall of the fixture. A membrane may be placed over the aperture. The membrane may serve to prevent moisture and other contaminants from entering the interior cavity (i.e., the membrane may be moisture-impermeable). The membrane may further allow passage of air into and out of the interior cavity (i.e., the membrane may be air-permeable). The LED may heat up during a conductive state of the LED and may cool down during non-conductive states, and thereby, may cause a higher or a lower pressure in the interior cavity than the pressure outside the fixture. Therefore, the membrane may facilitate air flow to normalize pressure (e.g., pressure equalization).

The membrane may be applied over the aperture through the use of a membrane applicator. The membrane applicator may be hand held and useable as a hand tool, or may be incorporated as part of an applicator system. The membrane applicator may include a housing, a shaft, and a biasing member. A channel may extend entirely or partially through the housing to receive the shaft therein. The shaft may be capable of telescoping, or reciprocal, movement with respect to the housing. Movement of the shaft may be facilitated between a first position and a second position.

The biasing member may be disposed between the housing and a first end of the shaft. The biasing member may be disposed to bias the first end of the shaft into the first position with a first force. The biasing member may be any suitable mechanism to bias the first end of the shaft to the first position. When the first end of the shaft is in the first position, the biasing member may have a first length.

The shaft may be moved to a second position by an applied force. For example, as the housing is moved toward the fixture, a second end of the shaft may contact the fixture such that the shaft is moved with respect to the housing. In this position the biasing member may exhibit a second force (e.g., a predetermined force that is optimized for proper placement of the membrane over the aperture) and a second length. The second force may be transferred along the length of the shaft from the biasing member to the second end such that the membrane is compressed by the second end of the shaft against the surface of the fixture. The second force may have a magnitude in proportion to a difference between the first length and the second length.

A contact member may be disposed at the second end of the shaft. The contact member may be formed of a flexible, resilient material which may allow flexing and conforming movement throughout a body or a portion of the body of the contact member. The flexing and conforming movement may operate to enable the contact member to align to and transfer a compressive force to a surface of the fixture. The contact member may facilitate application of the second force such that the membrane is applied to the fixture evenly. The second force may be applied substantially evenly to the membrane and/or to a circumference of the membrane.

The shaft may further include a first port and a second port. The first port may be positioned at the second end of the shaft and the second port may be positioned at a point along the length of the shaft. The first and second ports may be in fluidic communication with each other, which may include unidirectional or bidirectional flow. Fluidic flow may be facilitated by a pressurizing apparatus (e.g., a suction device). The pressurizing apparatus may be coupled to the second port such that fluidic communication may be provided between the first port and the pressurizing apparatus. The pressurizing apparatus may facilitate holding the membrane against the second end of the shaft. The membrane may be held against the second end of the shaft by negative pressure (e.g., suction).

The applicator may be part of an applicator system. The applicator system may be automated. The applicator may be coupled to a frame having one or more frame elements. The frame may receive the fixture in a predetermined mounted orientation. The frame may be capable of receiving a second fixture, or any of a plurality of other fixtures. Each of the first, second, and the plurality of other fixtures may be differently formed. “Differently formed” may be defined to mean that each fixture may be of a different size and/or shape. Each fixture may be capable of orientation with respect to the frame such that each of a plurality of apertures, respectively, are located substantially similarly with respect to the applicator.

The applicator may be movably coupled to the frame by an actuation system. The actuation system may include a first actuator coupled between the applicator and the frame. The first actuator may be configured to move the applicator into and out of engagement with the fixture. Movement of the applicator may be facilitated between a non-engaged position and an engaged position. In the non-engaged position the first end of the shaft may be in the first position, and in the engaged position the first end of the shaft may be in the second position. The actuation system may include a second actuator coupled between the applicator and the frame. The second actuator may be configured to move the applicator between a membrane pickup position and the non-engaged position.

The applicator system may include a dispensing system for dispensing the membrane to be held by the applicator. The dispensing system may include a dispensable material (e.g., paper, wax paper, plastic) with the membrane and a plurality of other membranes disposed thereon. The membranes may be coupled to the dispensable material in an array. The dispensable material may be dispensed over a decoupling element. The decoupling element may facilitate partial or full decoupling of the membrane or the plurality of membranes from the dispensable material. The dispensing system may include an actuating mechanism for causing the dispensable material to be dispensed across the decoupling element.

During operation of the applicator system, the dispensable material may be dispensed such that the membrane is partially decoupled from the dispensable material when the dispensable material is caused to pass over or around the decoupling element. Thus, the membrane may move from a coupled (e.g., fully adhered) position to a partially peeled position. The applicator may be positioned such that the second end of the shaft is disposed adjacent to or over the membrane when the membrane is coupled to the dispensable material in a partially peeled position. This position may correspond to a membrane pickup position of the applicator.

A pressurizing apparatus may be activated before or at the moment when the membrane passes under the second end of the shaft such that when the membrane is partially peeled from the dispensable material air flow through the first port has a catching effect and pulls the membrane from the dispensable material and holds the membrane against the second end of the shaft. Thus, the membrane may be moved from a partially peeled position to a fully peeled position wherein the membrane is no longer coupled to the dispensable material.

The applicator may be moved by the actuation system to bring the membrane into contact with the fixture. The actuation system may cause the second actuator to be actuated such that the applicator is moved from the membrane pickup position to the non-engaged position. The actuation system may further cause the first actuator to be actuated such that the applicator is moved from the non-engaged position to the engaged position, wherein the membrane is brought into contact with a surface of the fixture. After application of the second force (e.g., a predetermined force that is optimized for proper placement of the membrane against the surface of the fixture), the pressurization apparatus may be deactivated and the applicator may be moved back to the membrane pickup position by the first and second actuators.

During application of the membrane, the second end of the shaft contacts the fixture with an increasing force until the first end of the shaft moves from the first position to the second position. The increasing force is proportional to an increasing deflection of the biasing member. When the second force is reached (e.g., a predetermined force equal to an amount of force optimized for proper membrane placement), the applicator may be equipped with a programmable release. The programmable release may be capable of releasing the shaft when the shaft reaches a maximum force threshold. The programmable release may be capable of preventing the over-application of force to couple the membrane to the fixture.

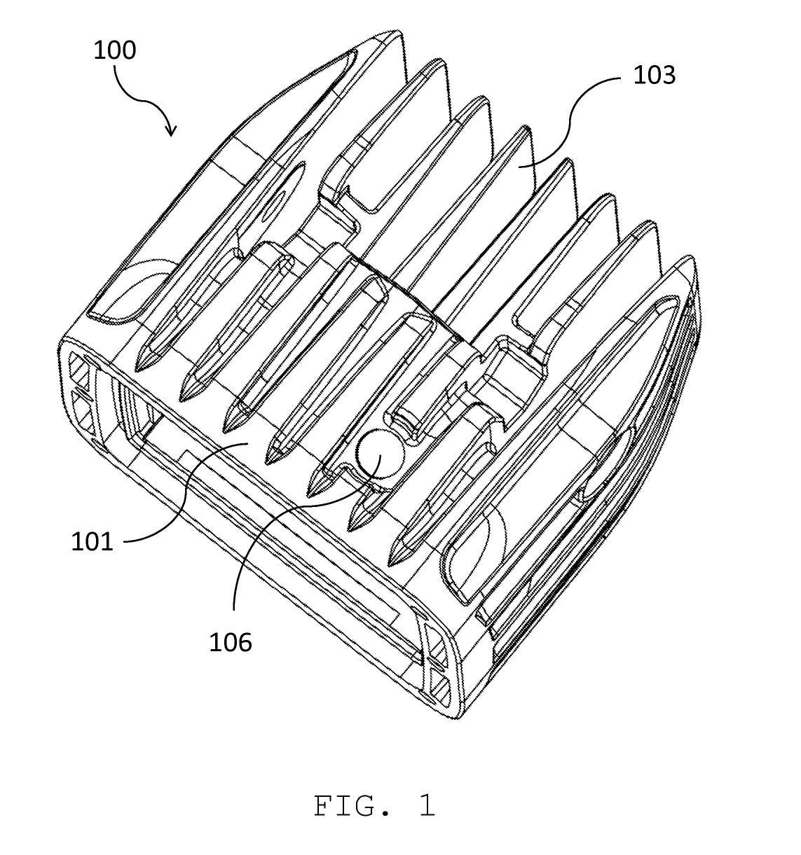

As shown in FIG. 1, a fixture 100 may contain a compartment 101 having an interior cavity. The fixture 100 may further include frame elements 103 extending from the compartment 101 on an exterior thereof. A membrane 106 may be coupled to the fixture 100 over an aperture extending through a wall of the compartment 101.

One or more light emitting diodes (LEDs), a printed circuit board (PCB), and associated circuitry may be disposed within the interior cavity. The interior cavity may be substantially sealed by seals (e.g., rubber, nylon, or other compliant material), thereby protecting the LEDs, PCB, and associated circuitry from moisture and other contaminants. The LEDs may heat up during operation, thereby producing heat within the interior cavity that may have the effect of increasing pressure within the cavity. Accordingly, the membrane 106 may be capable of allowing diffusion of air into and out of the interior cavity to normalize the pressure in the interior cavity with respect to the exterior of the fixture. In addition, the membrane 106 may be capable of preventing moisture and other contaminants from entering the compartment 101.

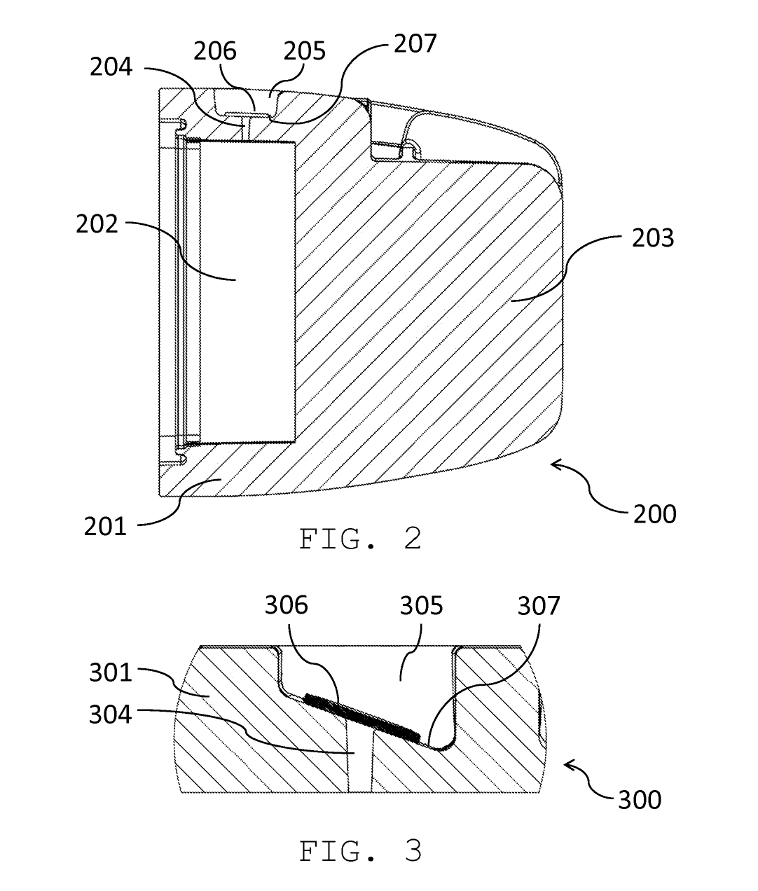

FIG. 2 shows a fixture 200 having a compartment 201, frame elements 203, and an interior cavity 202 within the compartment 201. The fixture 200 may further include a vent (e.g., aperture 204) passing entirely through a wall (e.g., sidewall, backwall, endwall) of the compartment 201. Further, the fixture 200 may include a recess 205 in either the frame elements 203, the compartment 201, or both, and may extend a distance less than the thickness of the compartment wall. The recess 205 may be adequately sized to extend around the aperture 204 and enable application of a membrane 206 to an application surface 207 of the recess 205. The membrane 206 may be applied over the aperture 204. The application surface 207 may be substantially parallel to an internal surface of the compartment 201, an outer surface of the fixture 200, or both.

The membrane 206 may be capable of preventing moisture and contaminants (i.e., membrane 206 may be moisture-impermeable) from entering the compartment 201. Further, the membrane 206 may be capable of allowing diffusion of air (i.e., membrane 206 may be air-permeable) into and out of the interior cavity 202 to normalize the pressure (e.g., pressure equalization) in the interior cavity 202 with respect to the exterior of the fixture (e.g., atmospheric pressure).

The aperture 204 may be cylindrically shaped through the wall of the compartment 201. The aperture may be any of a plurality of other shapes to facilitate pressure equalization between the interior and the exterior of the compartment 201. For example, the aperture 204 may be conical, tapered, and/or bowed, and may further be circular, oval, rectangular, polygonal, or have any other shaped cross-section, or combination thereof. Further, the aperture 204 may have grooves, ledges, changes in diameter, and other cross-sectional abnormalities along a length or disposed at a discrete point or points along the length of the aperture.

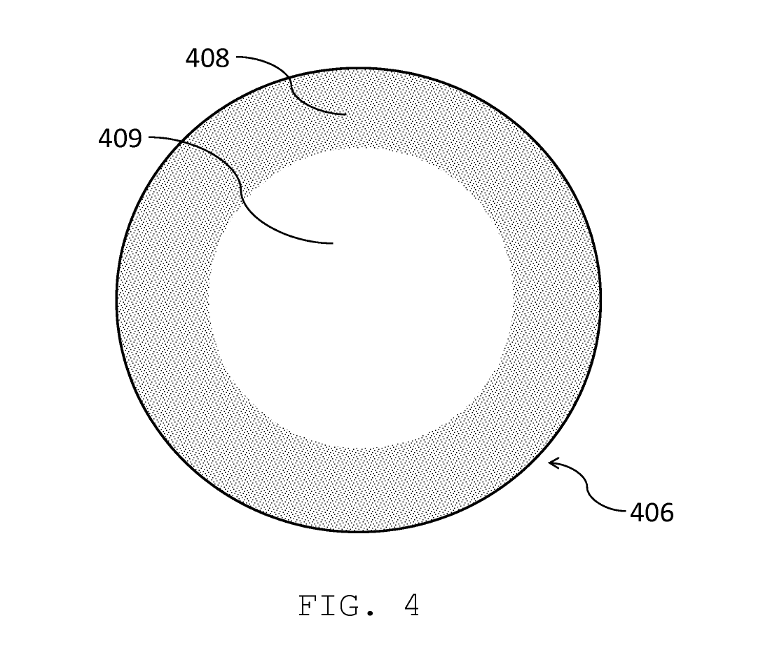

FIG. 3 shows an exploded view of a cross-section of a fixture 300. A compartment 301 may have an aperture 304. The aperture 304 may pass entirely through the compartment 301. The compartment 301 may have a recess 305 with an application surface 307 at a base of the recess 305. The recess 305 may extend only partially through the compartment wall. Application surface 307 may be non-parallel (e.g., at an angle) to an interior or an exterior surface of the compartment 301. The application surface 307 of FIG. 3 may be angled at any of a plurality of angles.

The membrane 306 may be capable of preventing moisture and contaminants (i.e., membrane 306 may be moisture-impermeable) from entering the compartment 301. Further, the membrane 306 may be capable of allowing diffusion of air (i.e., membrane 306 may be air-permeable) into and out of the interior cavity to normalize the pressure (e.g., pressure equalization) in the interior cavity with respect to the exterior of the fixture (e.g., atmospheric pressure).

FIG. 4 shows an air-permeable, moisture-impermeable, pressure equalization membrane. The membrane 406 may include a central region 409 capable of preventing moisture and contaminants from entering an aperture that is being covered by membrane 406 (e.g., aperture 204 of FIG. 2 or aperture 304 of FIG. 3). Further, the central region 409 may be capable of allowing diffusion of air into and out of a device (e.g., interior cavity 202 of fixture 200 of FIG. 2) to normalize the pressure in the interior cavity with respect to the exterior of the device.

The membrane 406 may further include an outer circumferential portion 408 which may have the air-permeable, moisture-impermeable, pressure equalization characteristics. The outer circumferential portion may further be capable of attachment (e.g., via adhesive) to a fixture (e.g., to application surface 207 within recess 205 of fixture 200 of FIG. 2). In order for optimum adhesion to occur, a predetermined amount of force may be exerted on circumferential portion 408 during application of membrane 406 to a respective application surface.

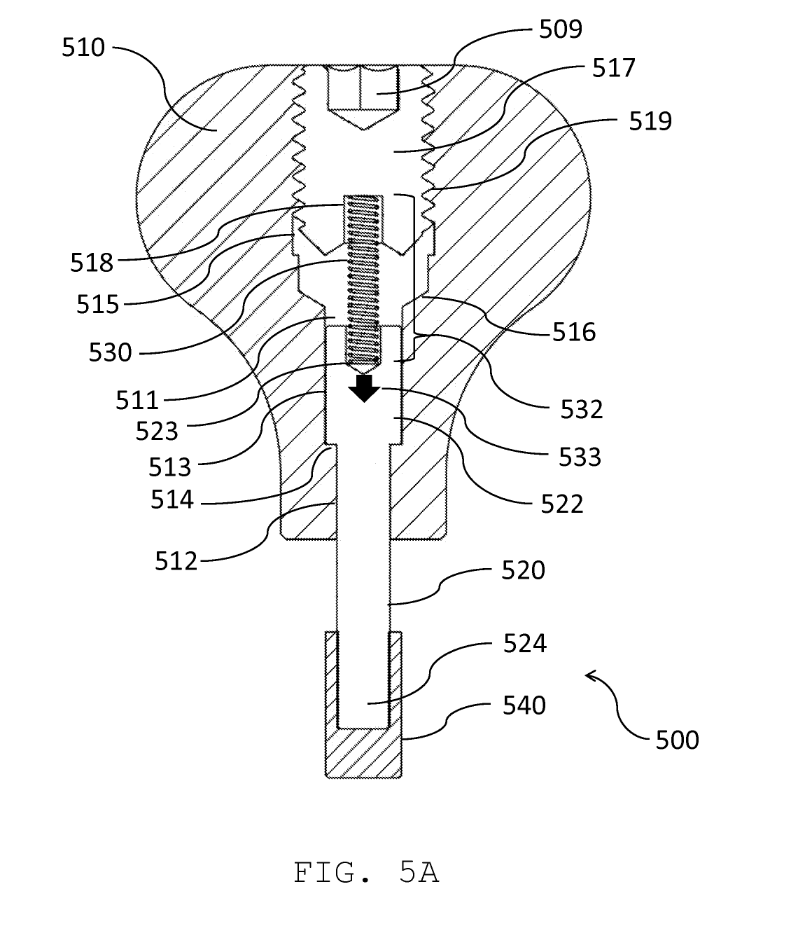

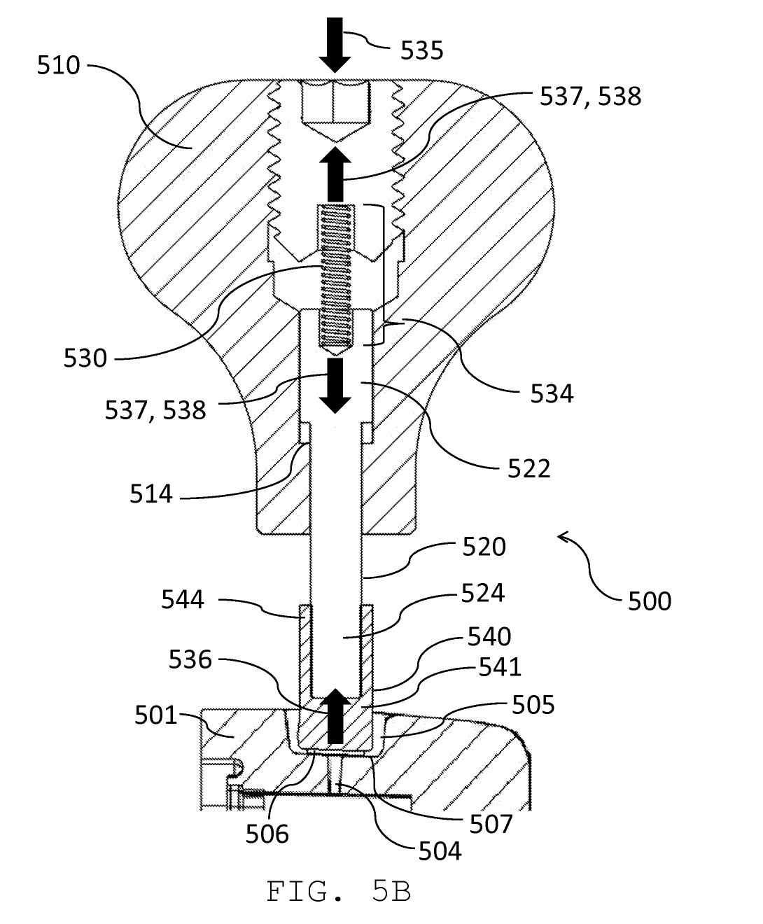

As exemplified in FIGS. 5A and 5B, applicator 500 may include a housing 510, a shaft 520, and a biasing member 530. The housing 510 of the applicator 500 may be formed of any suitable material (e.g., plastic, composite, metal) to facilitate use. The housing 510 may be shaped to be gripped by a hand of a user. In this fashion, the applicator 500 may be capable of use as a hand tool. Further, the housing 510 may be covered in a layer (not shown). The layer (not shown) may be capable of changing friction, thermal conduction, electrical conduction, or other qualities over the material of the housing 510.

An orifice 511 may extend entirely or partially through the housing 510. The orifice 511 may be of any suitable geometry (e.g., cylindrical) to accommodate the shaft 520, and may further include changes in geometry (e.g., tapered) along the length of the housing 510. The orifice 511 may be appropriately shaped to receive the shaft 520 within the housing 510 and may enable the shaft 520 to slide (e.g., telescopic movement) relative to the housing 510. For example, the orifice 511 may be shaped to allow the shaft 520 to move between a first position and a second position.

The orifice 511 may further include an open end 515, an upper portion 513, and a lower portion 512. Each of the open end 515, upper portion 513, and lower portion 512 may have geometric differences (e.g., differently shaped, dimensioned, or offset). The orifice 511 may include a transition (e.g., taper 516) between the open end 515 and the upper portion 513. The orifice 511 may further include a transition (e.g., shelf 514) between the upper portion 513 and the lower portion 512. Shelf 514 may operate as a stop to restrict travel of the shaft 520. As shown in FIG. 5A, shelf 514 may contact a corresponding shelf on the shaft 520 to stop movement of the shaft 520 at the first position.

Although the housing 510 is depicted as having the orifice 511 disposed therein for receiving the shaft 520, one of ordinary skill in the art will appreciate that alternate configurations are possible. For example, the shaft 520 may include an orifice to receive the housing 510 therein such that the shaft 520 is able to slide (e.g., telescopic movement) around an exterior of the housing 510.

Shaft 520 may have a first end 522 and a second end 524. The first end 522 of the shaft 520 may be received within the housing 510 (e.g., within orifice 511). The orifice 511 may be appropriately shaped to permit the first end 522 to slide (e.g., telescopic movement) between the first and second positions.

The biasing member 530 may be disposed between the housing 510 and the first end 522 of the shaft 520. Further, the housing 510 may include a plug 517, which may operate to partially or fully cap (e.g., close off) the orifice 511 at the open end 515. The plug 517 may contact the biasing member 530 at an upper end, and may further include a lower plug recess 518 for receiving an upper end of the biasing member 530. The lower plug recess 518 may operate to align and/or keep aligned the biasing member 530. The plug 517 may further include a threaded portion 519, which may engage with a similarly disposed threaded portion along at least a portion of the open end 515. Further, the plug 517 may include an upper plug recess 509, which may be shaped to facilitate engagement with a tool for moving the plug 517 with respect to the housing 510 (e.g., for tightening and/or loosening).

The shaft 520 may further include an upper recess 523, which may be configured for receiving a lower end of the biasing member 530. The upper recess 523 may operate to align and/or keep aligned the biasing member 530. Thus, the biasing member 530 may bias the first end 522 of the shaft 520 into the first position with a first force 533. In the first position, the biasing member 530 may exhibit a first length 532. The first length 532 may be more than, equal to, or less than an uninhibited length of the biasing member 530, such that the first force 533 may be greater than, less than, or equal to zero.

The first force 533 provided by biasing member 530 may be provided to keep contact between shelf 514 and a corresponding shelf of the shaft 520. The corresponding shelf of the shaft 520 may be located at a point along the length of the shaft 520. The first force 533 may hold the first end 522 of the shaft 520 in the first position, as shown in FIG. 5A. For example, the shelf 514 may resist the first force 533 with an equal and opposite force. The first force 533 may have a magnitude in proportion to a difference between the first length 532 and the uninhibited length of the biasing member 530.

The applicator 500 may be used to apply a membrane 506 to a compartment 501 of a fixture as exemplified in FIG. 5B. The membrane may be applied over an aperture 504 extending through a wall of the compartment 501. Further, the membrane 506 may be applied to an application surface 507 of a recess 505 extending through less than a full thickness of the wall of the compartment 501. To apply the membrane 506 to the compartment 501, the applicator 500 may be moved with respect to the fixture compartment 501. For example, the applicator may be moved toward the compartment 501. During movement, the second end 524 of the shaft 520 may come into coupling engagement with the application surface 507 of the compartment 501 (e.g., second end 524 of shaft 520 may come into direct or indirect contact with application surface 507 of compartment 501). The second end 524 of the shaft 520 may be appropriately sized and/or dimensioned to contact the application surface 507 and may be appropriately sized and/or shaped to fit within the recess 505.

When the second end 524 of the shaft 520 contacts the application surface 507, the shaft 520 may begin to move with respect to the housing 510. For example, the first end 522 of the shaft 520 may be moved between the first position and the second position. As a user of the applicator 500 applies an increasing amount of force (e.g., an applied force 535), this force may be resisted by the application surface 507 (e.g., a resistive force 536). For example, the increasing force may result in an increasing bias (e.g., biasing force 537) in the biasing member 530, which may be exhibited on the first end 522 of the shaft 520 and on the housing 510. As the applied force 535 is increased, there may be a corresponding increase in the resistive force 536 and/or the biasing force 537.

An increase in bias may correspond to an increasing amount of deflection of the biasing member 530. The applied force may be increased until the shaft 520 is moved to the second position (e.g., as shown in FIG. 5B). For example, the first end 522 of the shaft 520 may slide (e.g., via telescopic movement) from the first position to the second position. In the second position, shelf 514 is moved out of contact with the corresponding shelf of the shaft 520.

The biasing member 530 may exhibit a second force 538 (e.g., a predetermined force designed to exert an optimum magnitude of force on membrane 506) when the first end 522 of the shaft 520 is moved to the second position. Further, the biasing member 530 may exhibit a second length 534 in the second position, which may be more or less than the first length 532. The second force 538 may have a magnitude in proportion to a difference between the first length (e.g., length 532 of FIG. 5A) and the second length (e.g., length 534 of FIG. 5B) of the biasing member 530. For example, the applied force 535 may be applied and increased until the biasing member 530 deflects between the first length (e.g., length 532 of FIG. 5A) and the second length (e.g., length 534 of FIG. 5B). The deflection distance between the first length (e.g., length 532 of FIG. 5A) and the second length (e.g., length 534 of FIG. 5B) may correspond to an increase in the biasing force applied between the first end 522 of the shaft 520 and the housing 510. Further, the deflection distance may correspond to an increase from the first magnitude of force (e.g., force 533 of FIG. 5A) to the second magnitude of force (e.g., force 538 of FIG. 5B).

The shaft 520 may be rigid, such that the second force 538 is transferred along a length of the shaft 520 to the second end 524. The second force 538 may be transferred to any object brought into coupling engagement with the second end 524 of the shaft 520 (e.g., second end 524 may directly or indirectly contact the object). For example, the membrane 506 may be applied to an application surface 507 of a recess 505 with the second force 538. The second force 538 and the associated deflection to the second length 534 may be designed to exhibit a predetermined magnitude of force to sufficiently adhere the membrane 506 to application surface 507. The membrane 506 may be pinched between the second end 524 of the shaft 520 and application surface 507 via the second force 538 and the resistive force 536, respectively.

Although the biasing member 530 is depicted as a compression spring, one of ordinary skill in the art will appreciate that alternate and/or equivalent biasing configurations are possible. For example, a biasing configuration may include any of the following biasing mechanisms: coil springs, torsion springs, flat springs, cantilever springs, Belleville springs, negator springs, spring washers, bands, gas springs, compressed air, or any combination thereof. Furthermore, the biasing member 530 may be formed of any suitable material (e.g., plastic, composite, metal, air) to optimize the first force (e.g., force 533 of FIG. 5A) and/or the second force (e.g., force 538 of FIG. 5B).

A contact member 540 may be disposed at the second end 524 of the shaft 520. The contact member 540 may include an upper end 544 and a lower end 541. The upper end 544 may be configured to wrap around or enclose the second end 524 of the shaft 520, and may further be attached to the second end 524 of the shaft 520 (e.g., via adhesive). The lower end 541 of the contact member 540 may be of any suitable shape to facilitate contact with the membrane 506. For example, the lower end 541 may be cylindrical, tapered, beveled, ring-shaped, spherical, conical, or any other suitable shape.

The contact member 540 may be formed of a flexible, resilient material which may allow flexing and conforming movement throughout the body or a portion of the body of the contact member 540. The flexing and conforming movement may operate to enable the contact member 540 to align to and transfer the second force 538 to the application surface 507, whether the application surface 507 is in or out of alignment with the lower end 541 of the contact member 540.

As shown in FIG. 5B, the second force 538 may be transferred from the second end 524 of the shaft 520 to the membrane 506 through the contact member 540. The contact member 540 may be imperfectly aligned with the application surface 507, such that at least a portion of the contact member 540 resiliently flexes and conforms to the application surface 507. The flexing and conforming movement may enable the second force 538 to be applied substantially uniformly to the application surface 507 and/or the membrane 506. For example, the second force 538 may be applied substantially uniformly around an outer circumferential portion of the membrane (e.g., circumferential portion 408 of FIG. 4). The second force 538 may be applied to the outer circumferential portion of the membrane 506 to prevent damage to a central region having air-permeable, moisture-impermeable, pressure equalization characteristics (e.g., to circumferential portion 408, preventing damage to central region 409 of FIG. 4). Thus, the membrane 506 may be compressed and/or pinched between the application surface 507 and the second end 524 of the shaft 520 or between the application surface 507 and the lower end 541 of the contact member 540.

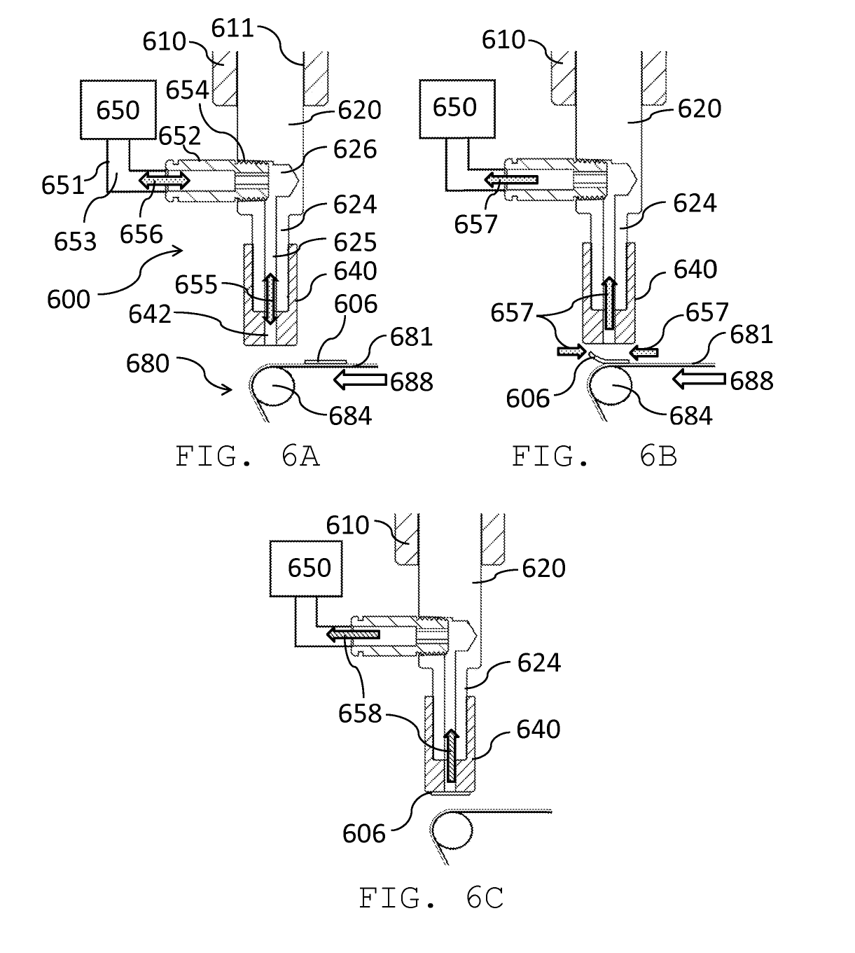

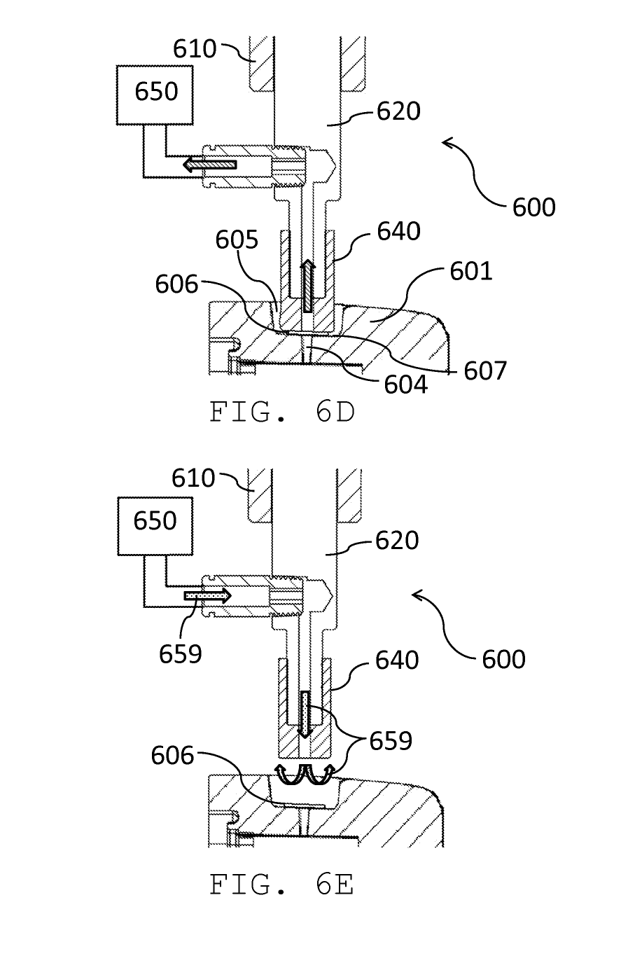

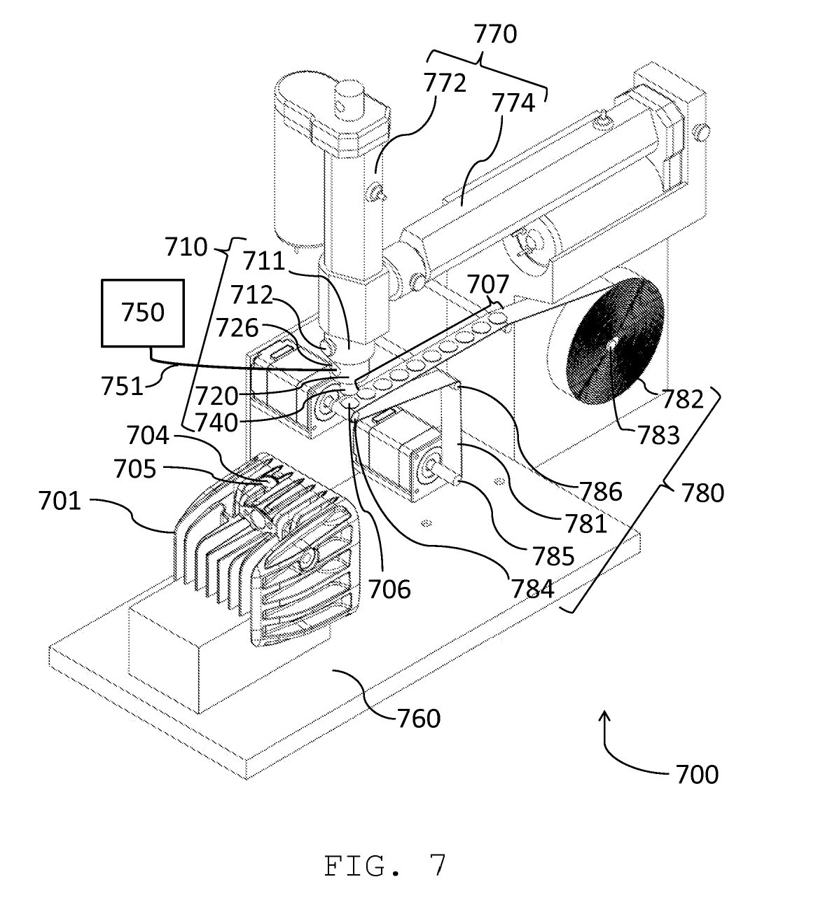

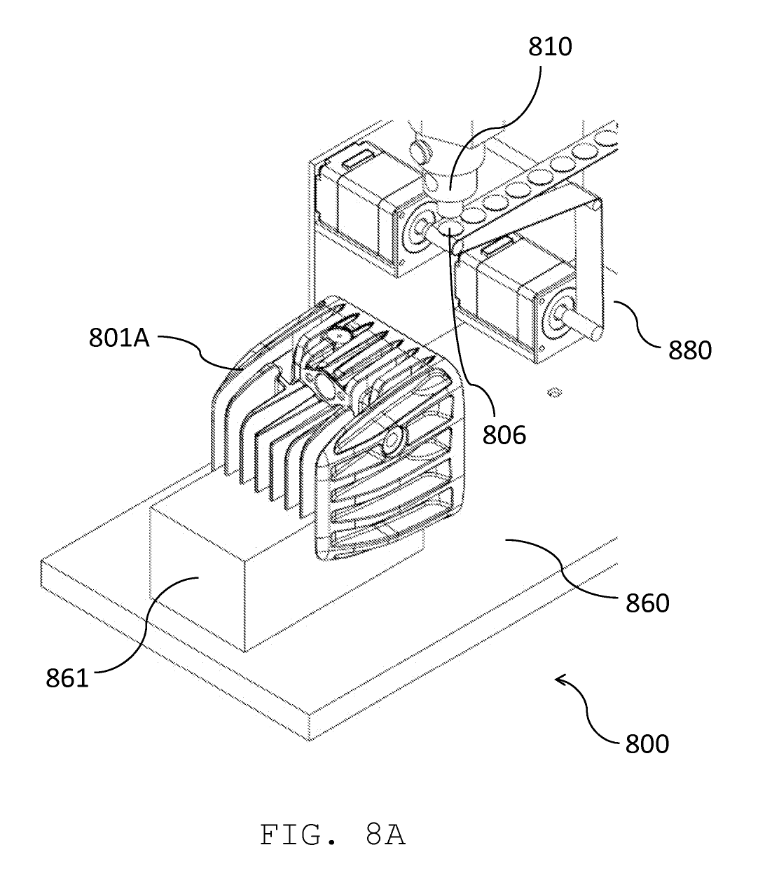

As exemplified in FIGS. 6A-6E, an applicator 600 may include a housing 610, a shaft 620, a biasing member (e.g., biasing member 530 of FIG. 5A), and one or more fluidic communication ports. The housing 610 may be capable of use as a hand tool, or may be used in an applicator system. An orifice 611 may extend entirely or partially through the housing 610. The shaft 620 may be capable of movement (e.g., between a first position and a second position) by sliding (e.g., telescopic movement) within the housing 610. The biasing member may be disposed between the housing 610 and the shaft 620, and may facilitate movement between the first and second positions.

The shaft 620 may have a first end (e.g., first end 522 of FIG. 5A) and a second end 624 extending out of the housing 610. The one or more fluidic communication ports may extend through the shaft 620 (e.g., through the first end, the second end 624, along a length of the shaft 620, or any combination thereof). The one or more fluidic communication ports may be capable of fluidic communication. For example, fluidic communication may be provided between a first port 625 and a second port 626. The first port 625 may be disposed in an end face of the second end 624 of the shaft 620 and the second port 626 may be disposed at a point along the length of the shaft 620. One of ordinary skill in the art will appreciate that alternate and/or equivalent configurations are possible. Further, the fluidic communication may include unidirectional or bidirectional flow (e.g., positive and/or negative flow 655 and 656). For example, fluid may pass from the first port 625 to the second port 626, from the second port 626 to the first port 625, or both.

Fluid flow may be facilitated by any suitable pressurizing apparatus (e.g., a suction device 650). The suction device 650 may be coupled with the second port 626. For example, an air hose 651 may extend from the suction device 650 to a coupling bracket 652. The coupling bracket 652 may be coupled to the second port 626, and may further include threads 654 configured for engagement with corresponding threads of the second port 626. The coupling bracket 652 and/or the air hose 651 may have a passage 653 to enable unidirectional or bidirectional flow (e.g., positive and/or negative flow 656) between the second port 626 and the suction device 650. In this way, fluidic communication may be provided between the suction device 650 and the first port 625 at the second end 624 of the shaft 620.

The shaft 620 may further include a contact member 640 disposed at the second end 624 of the shaft 620. The contact member 640 may include an opening 642 in fluidic communication with the first port 625. This configuration may allow fluidic communication between the suction device 650 and the opening 642 of the contact member 640.

If the applicator 600 is part of an applicator system, the applicator 600 may be positioned over a dispensing apparatus 680. The dispensing apparatus 680 may be capable of dispensing a membrane 606 to be held at the second end 624 of the shaft 620. The membrane 606 may be held as a result of the fluidic communication passing through the first port 625, the second port 626, the opening 642, or any combination thereof.

For example, a membrane 606 may be dispensed on a dispensed portion 681 of a dispensable material. The membrane 606 may be coupled to the dispensable material (e.g., by adhesion). The dispensable material may pass over or be caused to pass over a decoupling element 684 such that the membrane 606 is brought into close proximity with the second end 624 of the shaft 620. The direction of movement 688 of dispensed portion 681 is illustrated in FIG. 6A.

As illustrated in FIG. 6B, the membrane 606 may be moved until it is positioned directly above and/or in close proximity to the decoupling element 684. The membrane 606 may have different cross sectional dimensions than the dispensable material, and may be more or less rigid than the dispensable material. For example, as the membrane 606 passes over the decoupling element 684, the membrane 606 may be caused to partially decouple from the dispensed portion 681. The decoupling element 684 may cause the partial decoupling of the membrane 606. When partially decoupled, the membrane 606 may extend outwardly and/or away from a surface of the dispensed portion 681. Further, the dispensed portion 681 may move away from the membrane 606. For example, the dispensed portion 681 may be caused to pass around the decoupling element 684 at an angle too steep for the membrane 606 to stay fully coupled to the dispensed portion 681.

The suction device 650 may be activated at any time. For example, the suction device 650 may be activated either before the membrane 606 reaches the second end 624 of the shaft 620, at the moment the membrane 606 reaches the second end 624, or after the membrane 606 has passed beyond the second end 624. When activated, the suction device 650 may exhibit unidirectional flow (e.g., negative flow, or suction 657) in the area immediately around the second end 624 of the shaft 620 and/or in the area immediately around the membrane 606, which passes through the first port 625 and/or the second port 626 to the suction device 650. The suction 657 may cause the membrane 606 to be pulled upward and/or away from the dispensed portion 681, and may further cause the membrane 606 to be pulled toward the second end 624 of the shaft 620. For example, the membrane 606 may be pulled toward the contact member 640 as illustrated in FIG. 6B.

As the dispensed portion 681 continues to travel in the direction of movement 688, the membrane 606 may be fully decoupled from the dispensed portion 681. Once fully decoupled from the dispensed portion 681, the membrane 606 may be held in coupling engagement with the second end 624 of the shaft 620. For example, the membrane 606 may be held in coupling engagement with the contact member 640 (e.g., as shown in FIG. 6C). Once fully decoupled from the dispensed portion 681, the membrane 606 may no longer be in contact with the dispensed portion 681.

Engagement of the membrane 606 with the second end 624 of the shaft 620 may be facilitated by the suction 657, by movement of the dispensed portion 681 over the decoupling element 684, or both. The distance required to enable engagement may depend on the amount of fluidic communication through the first port 625, the size and/or weight of the membrane 606, and/or the manner in which the membrane 606 is attached to the dispensable material.

When the membrane 606 is held at the second end 624 of the shaft 620, the membrane 606 may form a partial or complete seal over the first port 625. Thus, fluidic flow through the first port 625, the second port 626 or the opening 642 may be substantially reduced fluidic flow (e.g., a second suction 658). The reduced fluidic flow may result in a higher, a lower, or a substantially similar suction, which may facilitate in holding the membrane 606 in coupling engagement with the second end 624 of the shaft 620.

Coupling engagement between the membrane 606 and the second end 624 of the shaft 620 may be further facilitated by movement of the shaft 620. For example, the shaft 620 may move toward and/or away from the membrane 606 before, during, or after the membrane is decoupled from the dispensed portion 681. Further, the shaft 620 may be brought into coupling engagement with the membrane 606 while the membrane 606 is fully coupled to the dispensed portion 681 of the dispensable material. The shaft 620 may be caused to move along with (e.g., parallel) to the direction of movement 688. For example, the shaft 620 may hover over the membrane 606 before the membrane 606 decouples from the dispensed portion 681 of the dispensable material. Further, the shaft 620 may move at substantially the same speed as the membrane 606. Further, the shaft 620 may catch and hold the membrane 606 and continue to move beyond the decoupling element along the direction of movement 688.

The shaft 620 may be brought into coupling engagement with an application surface 607 of a recess 605 extending through less than a full thickness of a wall of a compartment 601 (e.g., as illustrated in FIG. 6D). For example, the contact member 640 may be brought into coupling engagement with the application surface 607. The application surface 607 may not be perfectly aligned with the contact member 640, so the contact member 640 may be capable of flexing and/or resilient movement. The contact member 640 may be capable of conforming to the application surface 607.

The membrane 606 may be applied to the application surface 607 by the second end 624 of the shaft 620. For example, the membrane 606 may be applied to the application surface 607 by the contact member 640. Further, the membrane 606 may be pinched between the contact member 640 and the application surface 607 with a predetermined force exhibited by the biasing member (e.g., biasing member 530 of FIG. 5A). The predetermined force may be substantially uniformly exerted on the membrane 606 and/or on a circumferential portion of the membrane 606.

Once the membrane 606 comes into contact with the application surface 607, the suction device 650 may be deactivated. Alternately, fluidic flow through the suction device 650 may be reversed (e.g., positive flow 659 as illustrated in FIG. 6E). Fluidic flow may be deactivated and/or reversed before, during, or after the predetermined force is exerted. Deactivating or reversing fluidic flow may enable the second end 624 of the shaft 620 to be released from holding the membrane 606. Positive flow 659 may also be capable of use for cleaning the recess 605 of moisture and other contaminants. For example, the applicator 600 may be positioned to allow positive flow 659 to blow debris from the recess 605 prior to application of the membrane 606 on the application surface 607.

The suction may be broken by reversing fluid flow so that it passes from the suction device 650 to the first port 625, turning off fluid flow completely, or by pressing the membrane 606 against a surface of a fixture (e.g., where the membrane 606 includes a means for adhering to the surface and where the means is stronger than the suction created by the suction device 650). In this way, the suction device 650 may be operated to induce unidirectional fluid flow constantly, to induce unidirectional fluid flow intermittently, or to induce bidirectional fluid flow.

As mentioned previously, the applicator 600 may be used as a hand tool. When the applicator 600 is used as a hand tool, the membrane 606 may be applied to and held against the second end 624 of the shaft 620 in a substantially similar manner. For example, the applicator 600 may be moved such that the second end 624 of the shaft 620 is brought into coupling engagement with the membrane 606. At this time the membrane 606 may be coupled to a dispensable material. The suction device 650 may be activated either before or after the second end 624 is brought into coupling engagement with the membrane 606. The applicator 600 may then be pulled away from the dispensable material. For example, the applicator 600 may be pulled away orthogonally to the dispensable material or at any other suitable angle to facilitate peeling of the membrane 606 away from the dispensable material.

The membrane 606 may also be applied to a compartment 601 of a fixture in a substantially similar manner. For example, the applicator 600 may be moved such that the second end 624 of the shaft 620 brings the membrane 606 into coupling engagement with an application surface 607 of the compartment 601. After application, the suction device 650 may be deactivated, or fluidic communication may be reversed, which may result in decoupling of the membrane 606 from the second end 624 of the shaft 620. During application, the contact member 640 may be capable of flexing and resiliently deforming to adjust for misalignment of the applicator 600 within the recess 605. In this way, the predetermined force may be applied substantially uniformly to the membrane 606 and/or to a circumferential portion of the membrane 606.

As exemplified in FIG. 7, applicator system 700 may include a fixture 701, a membrane 706, and an applicator 710. The fixture 701 may include an aperture 704 passing completely through a sidewall of the fixture 701. The fixture may further include a recess 705 passing through less than a complete thickness of the sidewall. The aperture 704 may be disposed at a base of the recess 705, and may be disposed centrally. The membrane 706 may be an air-permeable, moisture-impermeable, pressure equalization membrane. The membrane 706 may be capable of application to the fixture 701 and may be disposed within the recess 705 to cover the aperture 704.

The applicator 710, though not shown in detail, may include a housing 711, a shaft 720, and a biasing member (e.g., biasing member 530 of FIG. 5A). The shaft 720 may include a first end and a second end. The first end of the shaft may be received within the housing 711, and further may be capable of telescoping movement with respect to the housing 711 between first and second positions. Housing 711 may be equipped with an adjustable stop (e.g., in the form of a knob 712). The stop 712 may extend from an exterior of the housing 711 to an interior and may engage the shaft 720 once inserted in the housing 711 to restrict travel of the shaft 720. The shaft 720 may be engaged by the stop 712 at a shelf portion or by any other suitable structure to position the shaft 720 against the biasing member in the first position.

The biasing member may be disposed between the first end of the shaft 720 and the housing 711. The biasing member may be configured to exert a first force against the shaft at the first position and to exert a second force (e.g., a predetermined force) against the shaft 720 at the second position. Further the biasing member may exhibit a first length at the first position and a second length at the second position.

The shaft 720 may further include a contact member 740 at the second end of the shaft 720. The contact member 740 may have an opening in fluidic communication with an outlet 726 located at a point along a length of the shaft 720. Further, the contact member 740 may be formed of a flexible, resilient material and may cause the second force (e.g., the predetermined force) to be substantially uniformly applied around a circumference of the membrane 706 when the membrane 706 is applied to the fixture 701. The second force may have a magnitude in proportion to a difference between the first and second lengths of the biasing member.

The applicator system 700 may additionally include a frame 760 composed of one or more frame elements. In this configuration, for example, the applicator 710 may be coupled to the frame 760. The frame 760 may further be configured and/or adapted for receiving a fixture 701 in a predetermined mounted orientation. The frame 760 may be capable of receiving multiple fixtures, or may be capable of receiving fixtures of varying sizes, shapes, and geometries, each in predetermined mounted orientations. The frame 760 may be capable of mounting each of the fixture 701 or fixtures such that the respective aperture 704 or apertures are located substantially similarly with respect to the applicator 710.

The predetermined mounted orientation may enable the aperture 704 of the fixture 701 to be in substantial alignment with an axis of travel of the second end of the shaft 720. In this way, the contact member 740 may be ensured to pass into the recess 705 for application of the membrane 706 to a surface of the fixture 701 and covering the aperture 704.

The applicator system 700 may additionally include a suction device 750. The suction device 750 may be coupled to the outlet 726 of the shaft 720 by any suitable means. One suitable means may include an air hose 751 extending from the suction device 750 to the outlet 726. The suction device 750 may facilitate fluidic communication between the outlet 726 and the suction device 750 such that fluid may flow from the opening in the contact member 740 to the suction device 750, from the suction device 750 to the opening in the contact member 740, or both. The suction device 750 may operate to maintain a coupling between the membrane 706 and the contact member 740 at the second end of the shaft 720. The suction device 750 may be mounted to the frame 760 or at any other suitable location. The suction device 750 may further be pneumatic, or may enable fluidic communication of any other suitable fluid.

The applicator system 700 may additionally include an actuation system 770. The actuation system 770 may be generally provided for moving the applicator 710 with respect to the fixture 701. The actuation system 770 may include a first actuator 772. The first actuator 772 may be in coupling engagement with the frame 760 and the applicator 710. The first actuator 772 may have an axis of motion parallel to an axis of motion of the shaft 720, and may operate to move the shaft 720 and/or the contact member 740 into and out of engagement with the fixture 701. Movement of the applicator 710 may be facilitated between a non-engaged position wherein the first end of the shaft 720 is in the first position, and an engaged position with the fixture 701 wherein the first end of the shaft 720 is in the second position.

The actuation system 770 may further include a second actuator 774. The second actuator 774 may be in coupling engagement with the frame 760 and the applicator 710. The second actuator 774 may have an axis of motion non-parallel to an axis of motion of the shaft 720. Movement of the applicator 710 may be facilitated between a membrane pickup position and a non-engaged position wherein the first end of the shaft 720 is in the first position.

The actuation system 770 may include the first actuator 772, the second actuator 774, or both. The non-engaged position of the second actuator 774 may correspond to the non-engaged position of the first actuator 772 if both actuators are present in the system. Furthermore, in the non-engaged position of both actuators, an axis of motion of the shaft 720 (e.g., the second end) may be substantially in alignment with the aperture 704, the recess 705, or both. The first and second actuators may be powered by any suitable powering means (e.g., electric, solenoid, magnetic, pneumatic, mechanical, etc.).

The applicator system 700 may additionally include a dispensing system 780, which may be provided for dispensing the membrane 706 to be held by the applicator 710. The dispensing system 780 may include a dispensable material 782. The dispensable material 782 may be any suitable material (e.g., paper, wax paper, plastic) to enable decoupling of the membrane 706 by the applicator 710. The dispensable material 782 may be dispensable from any suitable form (e.g., roll, sheet). Further, the dispensable material 782 may be mounted to the frame 760 by any suitable mounting means to facilitate dispensing. As exemplified in FIG. 7, the dispensable material 782 may be a roll mounted for rotational dispensing by a stationary or rotating dispenser (e.g., pin 783). The dispensable material may have at least the membrane 706 positioned thereon (e.g., by adhesion), and may further include an array of similarly disposed membranes 707.

The dispensing system 780 may further include a decoupling element 784. The decoupling element 784 may be generally provided for initiating a decoupling of the membrane 706 or array of membranes 707. The decoupling element 784 may be positioned in close proximity to the second end of the shaft 720 of the applicator 710 when the applicator 710 is in the membrane pickup position. The decoupling element 784 may be coupled to the frame 760 and may be stationary or coupled for rotation about an axis.

A dispensed portion 781 of the dispensable material 782 may be positioned adjacent the decoupling element 784. For example, the dispensed portion 781 may pass over and/or around a portion of the decoupling element 784, as shown in FIG. 7. The decoupling element 784 may further include raised portions or flanges, which may operate to align the dispensed portion 781 of the dispensable material 782. The decoupling element 784 may have one or more features (e.g., a radius) which facilitate decoupling of the membrane 706 and/or array of membranes 707 from the dispensed portion 781 of the dispensable material 782. For example, the decoupling feature may cause the membrane 706 or membranes 707 to move from an unpeeled position on the dispensable material 782 to a partially peeled position on the dispensed portion 781 when positioned substantially adjacent and/or over the decoupling element 784.

The dispensing system 780 may further include an actuating mechanism 785, which may be provided for causing the dispensable material 782 to be dispensed and may further cause the dispensed portion 781 to pass adjacent the decoupling element 784. The actuating mechanism 785 may be powered by any suitable powering means. In FIG. 7, the actuating mechanism 785 is depicted as a winding mechanism for pulling the dispensable material 782. One skilled in the art will appreciate that alternate and/or equivalent configurations are possible. For example, the actuating mechanism 785 may be coupled to the dispenser (e.g., via pin 783), and may operate to push the dispensable material 782.

The dispensing system 780 may further include one or more guides 786. The guides 786 may be disposed in any suitable configuration to facilitate alignment and dispensing of the dispensable material 782. Further, the guides 786 may have any suitable shape, may be stationary or rotate about individual axes, and may be formed of any suitable material (e.g., plastic, composite, metal).

When the dispensing system 780 is present, the applicator 710 may be positioned substantially adjacent and/or over the decoupling element 784. Further, the dispensed portion 781 of the dispensable material 782 may pass through a gap between the decoupling element 784 and the applicator 710 (e.g. the second end of the shaft 720 and/or the contact member 740). In this configuration, the dispensed portion 781 may be dispensed through the gap by the actuating mechanism 785. During a dispensing operation the membrane 706 or array of membranes 707 may pass into the gap in sequence. The membrane 706 may be in an unpeeled position (e.g., fully coupled) on the dispensable material 782 prior to passing into the gap.

Upon entering the gap, the decoupling element 784 may cause the membrane 706 to partially decouple from the dispensed portion 781 of the dispensable material 782. As a result of the partial decoupling, the membrane 706 may move from an unpeeled position to a partially peeled position. This partial decoupling may, for example, be facilitated by the membrane 706 being more rigid than the dispensable material 782. In this configuration, when the dispensed portion 781 is bent and/or wrapped tightly around the decoupling element 784, the membrane 706 may be incapable of remaining fully coupled to the dispensed portion 781 at a forward end of the membrane 706, and may thus partially decouple to a partially peeled position. The array of membranes 707 may be partially decoupled in like manner.

When fluidic communication is enabled through the inlet in the shaft 720 (e.g. and/or through the opening in the contact member 740), fluidic flow is induced in the area immediately around the second end of the shaft 720. The relative positions of the applicator 710 and the membrane 706 (e.g., a partially decoupled membrane 706) may be optimized so that fluidic flow is induced across and/or around the membrane 706.

Fluidic flow may be configured to travel from the area immediately around the second end of the shaft 720, along and/or adjacent to the membrane 706, and into the inlet of the shaft 720. The flow may induce a catching effect on the partially peeled portion of the membrane 706, such that the partially peeled portion may be pulled upward and/or toward the second end of the shaft 720 (e.g. into contact with the contact member 740). In this manner, the membrane 706 may be caused to fully decouple from the dispensed portion 781 of the dispensable material 782, such that the membrane 706 may move from a partially peeled position to a fully peeled position. The array of membranes 707 may be fully decoupled in like manner.

The applicator system 700 may also include a number of detection mechanisms (e.g., sensors). The detection mechanisms may be capable of determining positioning of any component of the system, detecting pressure, detecting fluid pressure, detecting defects at any point in the system, detecting temperature, detecting speed and/or acceleration, detecting torque, and chemical detection. Detection mechanisms may be applied to the applicator system 700 in any way to facilitate optimized operation of the system. Optimization may, for example, be accomplished by reducing defects, increasing speed of operation, reducing vibration, increasing longevity of any and all components of the system, or by any other metric.

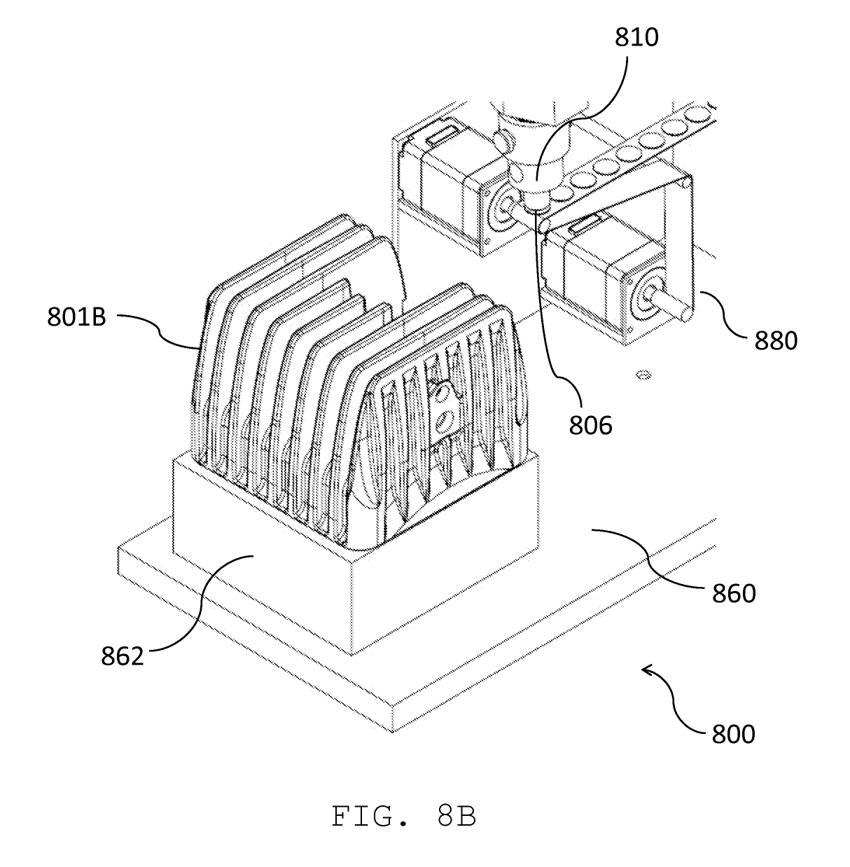

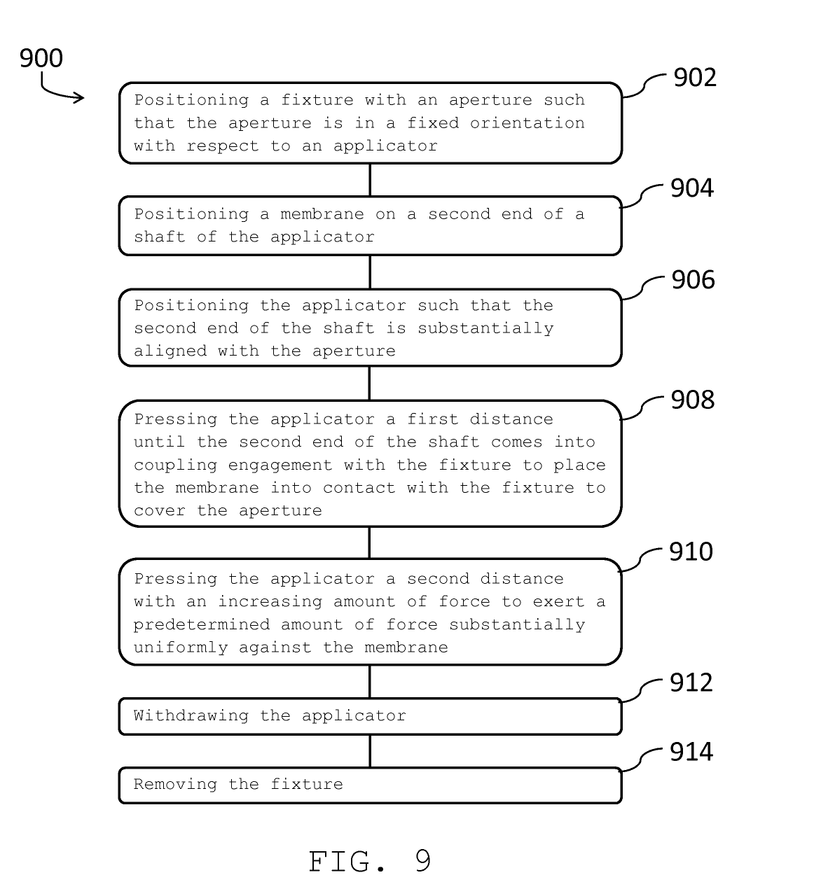

As exemplified in FIGS. 8A and 8B, an applicator system 800 may include an applicator 810, a frame 860, and a dispensing system 880. The frame 860 may be configured to orient a fixture (e.g., fixture 801A of FIG. 8A) with respect to the applicator 810. The dispensing system 880 may be configured to dispense a membrane 806 to the applicator 810. The applicator 810 may be configured to receive the membrane 806 from the dispensing system 880, and may further be configured to deliver the membrane 806 to a surface of a fixture (e.g., fixture 801A of FIG. 8A).

The applicator 810 may include a housing, a shaft, a biasing member, and a suction device 850 (e.g., suction device 750 of FIG. 7) to induce fluidic communication through the applicator 810. The fluidic communication may facilitate movement of the membrane 806 from the dispensing system 880 to the surface of the fixture (e.g., fixture 801A of FIG. 8A).

The frame 860 may be capable of holding a fixture (e.g., fixture 801A of FIG. 8A, fixture 801B of FIG. 8B), or any of a plurality of other fixtures. Alternately, the frame 860 may be capable of holding the fixture 801A and the fixture 801B individually and/or simultaneously. The frame 860 may be capable of holding any of the plurality of other fixtures individually and/or simultaneously.

The fixture 801A may be held in a fixed orientation with respect to the frame 860 by means of a jig 861. The fixture 801B may be held in a fixed orientation with respect to the frame 860 by means of a jig 862. Any of the plurality of other fixtures may also be held in fixed orientations with respect to the frame 860 by means of a plurality of jigs, respectively. Alternately, one jig may be capable of holding fixture 801A, fixture 801B, and each of the plurality of other fixtures in fixed orientations with respect to the frame 860. Although the frame 860 has been illustrated as a separate, though connectable, component from jig 861 and jig 862, one of ordinary skill in the art will appreciate that each or both jigs may be integrally formed with frame 860.

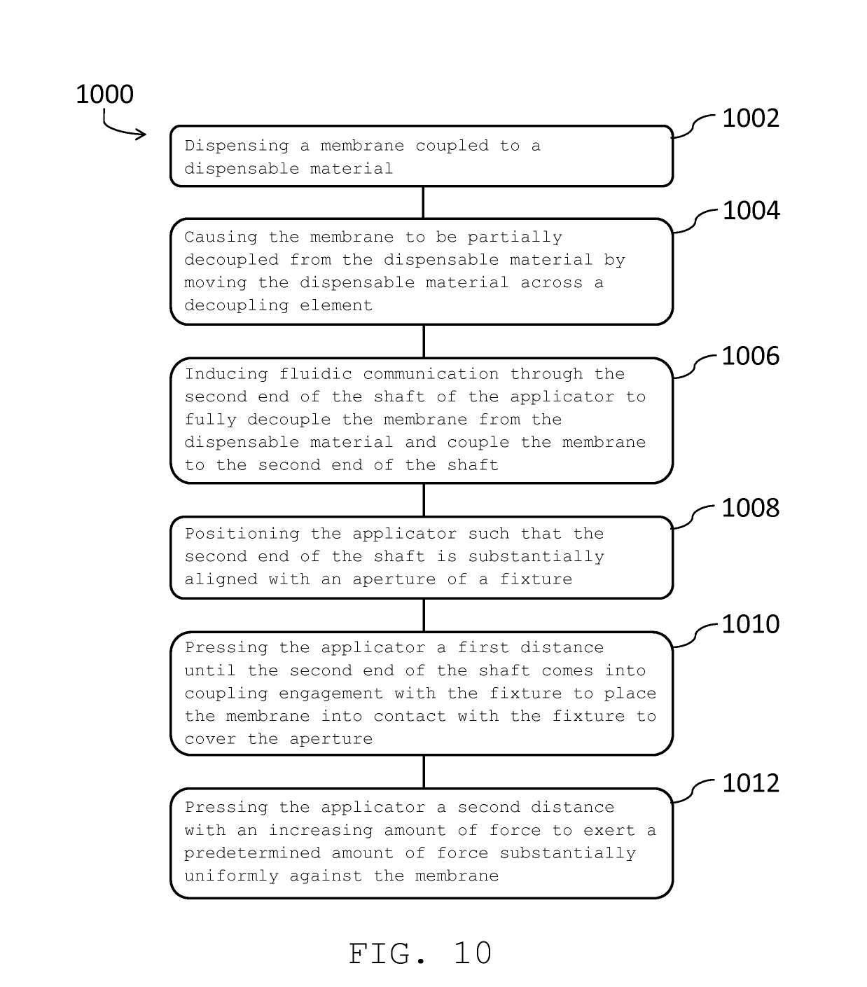

A method 900 of FIG. 9 may be provided for applying a membrane to a fixture. The method may include positioning the fixture with respect to the applicator (e.g., as in step 902), positioning a membrane on the applicator (e.g., as in step 904), aligning the applicator with an aperture of the fixture (e.g., as in step 906), pressing the applicator into contact with the fixture (e.g., as in step 908), pressing the applicator with a predetermined force (e.g., as in step 910), withdrawing the applicator (e.g., as in step 912), and removing the fixture (e.g., as in step 914).

In step 902, positioning the fixture with respect to the applicator may further comprise locating an aperture on the fixture with respect to the applicator, such that the aperture is in a fixed orientation with respect to the applicator.

In step 904, positioning the membrane on the applicator may be accomplished by dispensing a membrane to the applicator. The membrane may be held against the applicator (e.g., at the second end of the shaft of the applicator) by inducing fluidic communication through the applicator.

In step 906, aligning the applicator with an aperture of the fixture 906 may be accomplished by positioning a shaft of the applicator adjacent and/or over the fixture. Further, the applicator may be located such that a second end of the shaft of the applicator is aligned with the aperture of the fixture.

In step 908, pressing the applicator into contact with the fixture may be accomplished by pressing the applicator a first distance, such that the second end of the shaft comes into coupling engagement with the fixture. The movement may cause the membrane to be placed into contact with the fixture, and the membrane may be placed to cover the aperture of the fixture. Prior to pressing, the first end of the shaft may be in a first position relative to the applicator. After pressing a distance (e.g., the first distance), the first end of the shaft may remain in the first position relative to the applicator.

In step 910, pressing the applicator with the predetermined force may be accomplished by pressing the applicator a second distance, such that an increasing amount of force is applied until the predetermined amount of force is applied. The predetermined amount of force may be applied substantially uniformly against the membrane and/or against a circumference of the membrane. After pressing a distance (e.g., the second distance), the first end of the shaft may be in a second position relative to the applicator.

In step 912, withdrawing the applicator may include moving the applicator opposite to the movement of the applicator during the pressing steps. Movement may be in any direction that would facilitate the removal of the applicator from contact with the fixture and/or the membrane. When the applicator is withdrawn, the first end of the shaft may move from the second position to the first position. The second end of the shaft may no longer be substantially aligned with the aperture of the fixture.

In step 914, removing the fixture may include decoupling the fixture from the fixed orientation with respect to the applicator.

A method 1000 of FIG. 10 may be provided for applying a membrane to a fixture. The method may include dispensing a membrane on a dispensable material (e.g., as in step 1002), partially decoupling the membrane from the dispensable material (e.g., as in step 1004), fully decoupling the membrane from the dispensable material (e.g., as in step 1006), positioning an applicator with respect to a fixture (e.g., as in step 1008), pressing the applicator into contact with the fixture (e.g., as in step 1010), and pressing the applicator with a predetermined force (e.g., as in step 1012).

In step 1002, a membrane may be dispensed on a dispensable material, which may be a roll, a sheet, any other suitably dispensable material, or any combination of these dispensable materials. When on the dispensable material, the membrane may be in an unpeeled position. The membrane may be coupled to the dispensable material by any suitable means (e.g., adhesion). The dispensable material may be dispensed from a dispenser to a decoupling element, such that a dispensed portion extends from the dispenser to the decoupling element. The dispensed portion may pass adjacent and/or over guides. The guides may guide the movement and maintain alignment of the dispensed portion. The dispensed portion may be moved (e.g., dispensed) by an actuating mechanism. The actuating mechanism may move the dispensed portion by pushing, pulling, or otherwise moving the dispensable material. The dispensed portion may pass adjacent and/or over the decoupling element.

In step 1004, partially decoupling of the membrane from the dispensable material may be accomplished by the decoupling element. The dispensed portion of the dispensable material may be moved across the decoupling element to partially decouple the membrane. The decoupling element may be shaped to facilitate decoupling of the membrane from the dispensed portion. Further, the membrane may be more rigid than the dispensable material. The decoupling element may, therefore, be shaped to permit the dispensed portion to be pulled away from the membrane (e.g., along an adhered surface). The decoupling element may be shaped and/or structured to only cause the membrane to be partially pulled away from the membrane. When the dispensed portion engages the decoupling element, the membrane may be moved from an unpeeled position (e.g., fully adhered) to a partially peeled position (e.g., partially adhered). In this position, a portion of the membrane may no longer be coupled to the dispensable material, and may extend away from the dispensed portion.

In step 1006, fully decoupling the membrane from the dispensable material may include positioning an applicator adjacent and/or over the decoupling element. The applicator may be positioned at a membrane pickup position. The applicator may be substantially aligned with the membrane and/or a partially peeled portion of the membrane. In this position, the second end of the shaft may be substantially aligned with the membrane and/or a partially peeled portion of the membrane.

In step 1006, fully decoupling the membrane may further include inducing fluidic communication through the applicator. Fluidic communication may be induced by a suction device. Fluidic communication may be induced through the second end of the shaft of the applicator and/or through a contact member at the second end of the shaft (e.g., through an inlet). Fluidic communication may cause the membrane to be fully decoupled from the dispensable material (e.g., from a partially peeled position to a fully peeled position). Fluidic communication may pass from an area immediately around the applicator, past the peeled membrane, and into the applicator. Fluidic communication may have a catching effect on the membrane, and may cause the membrane to lift upward and/or away from the dispensed portion of the dispensable material (e.g., from a partially peeled position to a fully peeled position).

When the membrane fully decouples from the dispensable material, the membrane may be in a fully peeled position. In the fully peeled position, the membrane may no longer be in contact with the dispensable material, and may be held in engagement with the applicator (e.g., to the second end of the shaft and/or to the contact member) by a suitable means, and further may be held to substantially cover an inlet at the second end of the shaft and/or the contact member. The contact may be maintained by the fluidic communication. Fluidic communication may be substantially reduced while the membrane is held against the applicator (e.g. when the membrane substantially covers the inlet). Holding the membrane against the applicator and over an inlet of the shaft may have the effect of causing negative pressure (e.g., a suction) at the second end of the shaft. The negative pressure may hold the membrane against the second end of the shaft.

In step 1008, positioning an applicator with respect to a fixture may include moving the applicator adjacent and/or over a fixture. The applicator may be moved along a first axis of motion and further may be moved by a first actuator. The applicator may be moved from the membrane pickup position to a non-engaged position. In the non-engaged position, the applicator may be substantially aligned with an aperture of the fixture. In the non-engaged position, the second end of the shaft may be aligned with the aperture, and the first end of the shaft may be in a first position with respect to the applicator.

In step 1010, pressing the applicator into contact with the fixture may include moving the applicator a first distance. The applicator may be moved along a second axis of motion and further may be moved by a second actuator. The applicator may be moved from the non-engaged position to an intermediate position wherein the second end of the shaft comes into coupling engagement with the fixture. At the intermediate position, the membrane may be placed into contact with the fixture and further may cover the aperture of the fixture. In the intermediate position, the first end of the shaft may remain in the first position with respect to the applicator.

In step 1012, pressing the applicator with a predetermined force may include moving the applicator a second distance. For the second distance, the applicator may be moved along the second axis of motion and further may be moved by the second actuator. The applicator may be moved from the intermediate position to an engaged position wherein an increasing amount of force is applied until a predetermined amount of force is applied. The predetermined force may be applied substantially uniformly against the membrane and/or against a circumference of the membrane. In the engaged position, the first end of the shaft may be in a second position with respect to the applicator.

The method may further comprise stopping and/or reversing fluidic communication after the membrane is placed into contact with the fixture. Fluidic communication may be stopped by disengaging the suction device and/or reversed by the suction device. Stopping and/or reversing fluidic communication may break the negative pressure (e.g., the suction) holding the membrane against the second end of the shaft.

The method may further include sensing positioning of components of the invention. The method may include sensing movement, speed, or acceleration of components of the invention. The method may include sensing pressure of the fluidic communication, or sensing pressure of the force applied against the membrane. Other elements of pressure may also be measured. The method may include identifying defects by using vision systems and other sensing configurations. The method may include sensing temperature, torque, or any other measurable criteria for optimizing performance of the method. Optimization may, for example, be accomplished by reducing defects, increasing speed of operation, reducing vibration, increasing longevity of any and all components of the system, or by any other metric known in the art of manufacture.

Other aspects and embodiments of the present invention will be apparent to those skilled in the art from consideration of the specification and practice of the invention disclosed herein. It is intended, therefore, that the specification and illustrated embodiments be considered as examples only, with a true scope and spirit of the invention being indicated by the following claims.

What is claimed is:

1. An applicator, comprising:
a housing;
a shaft having a first end and a second end, the first end being received within the housing at first and second positions, the second end having an inlet in fluidic communication with an outlet located at a point along a length of the shaft; and
a biasing member disposed between the first end of the shaft and the housing, wherein the biasing member exhibits a first length at the first position and a second length at the second position, wherein the biasing member exerts a predetermined force on the second end of the shaft, the predetermined force having a magnitude in proportion to a difference between the first and second lengths.

2. The applicator of claim 1, further comprising a contact member coupled to the second end of the shaft, wherein the contact member is formed of a flexible material.

3. The applicator of claim 1, wherein the housing is a handle, such that the membrane applicator is used as a hand tool.

4. The applicator of claim 1, wherein the housing includes a plug contacting the biasing member, the plug threadably engaged within the housing.

5. A membrane applicator system, comprising:
a fixture having an aperture therein;
a membrane coupled to the fixture and covering the aperture; and
an applicator configured to press the membrane against the fixture, the applicator including,
a housing;
a shaft having a first end and a second end, the first end capable of telescoping movement with respect to the housing between first and second positions; and
a biasing member disposed between the first end of the shaft and the housing, the biasing member configured to exert a first force against the shaft at the first position and exert a second force against the shaft at the second position, wherein the second force is substantially uniformly applied around a circumference of the membrane.

6. The membrane applicator system of claim 5, wherein the shaft further includes a contact member at the second end, the contact member having an inlet and an outlet located at a point along a length of the shaft.

7. The membrane applicator system of claim 6, wherein the applicator system further including a suction device coupled to the outlet, the suction device configured to cause fluid flow between the inlet and the outlet.

8. The membrane applicator system of claim 5, wherein the shaft further includes a contact member at the second end, the contact member formed of a flexible material to cause the second force to be substantially uniformly applied around the circumference of the membrane.

9. The membrane applicator system of claim 5, wherein the biasing member exhibits a first length at the first position and a second length at the second position, the biasing member configured to exert a predetermined force to press the membrane against the fixture, the predetermined force having a magnitude in proportion to a difference between the first and second lengths.

10. The membrane applicator system of claim 5, further comprising:
a frame coupled to the applicator, the frame configured for mounting any one of a plurality of differently formed fixtures thereon for orientation with respect to the applicator, each fixture having an aperture;
wherein an axis of travel of the second end of the shaft is substantially in alignment with any one aperture.

11. A method comprising:
positioning a membrane on a second end of a shaft of an applicator;
pressing the applicator until the second end of the shaft comes into coupling engagement with a fixture to place the membrane into contact with the fixture to cover an aperture on the fixture, a first end of the shaft being in a first position relative to the applicator;
pressing the applicator with an increasing amount of force until the first end of the shaft is placed in a second position relative to the applicator to exert a predetermined amount of force substantially uniformly against a circumference of the membrane.

12. The method of claim 11, further comprising positioning the fixture with respect to the applicator such that the aperture of the fixture is in a fixed orientation with respect to the applicator.

13. The method of claim 11, further comprising withdrawing the applicator such that the first end of the shaft returns to the first position.

14. A membrane applicator system, comprising:
a frame;
a fixture having an aperture therein, the fixture removably coupled to the frame;
a membrane coupled to the fixture and covering the aperture;
an applicator configured to press the membrane against the fixture, the applicator including,
a housing coupled to the frame;
a shaft having a first end and a second end, the first end being received within the housing at first and second positions, the second end having an inlet, and an outlet located at a point along a length of the shaft; and
a biasing member disposed between the first end of the shaft and the housing, the biasing member configured to exert a first force against the shaft at the first position and exert a second force against the shaft at the second position, wherein the second force is substantially uniformly applied around a circumference of the membrane; and
a suction device coupled to the outlet in fluidic communication between the inlet and the outlet to maintain a coupling between the membrane and the applicator.

15. The membrane applicator system of claim 14, wherein the shaft further includes a contact member at the second end, the contact member configured to apply the second force substantially uniformly around the circumference of the membrane.

16. The membrane applicator system of claim 14, further comprising:
a first and a second actuator coupled between the housing and the frame;
wherein the first actuator has an axis of motion parallel to an axis of motion of the shaft, such that the second end of the shaft is movable between a non-engaged position wherein the first end of the shaft is in the first position, and an engaged position with the fixture wherein the first end of the shaft is in the second position;
wherein the second actuator has an axis of motion non-parallel to an axis of motion of the shaft, such that the second end of the shaft is movable between a membrane pickup position and the non-engaged position wherein the first end of the shaft is in the first position and an axis of motion of the second end is substantially in alignment with the aperture.

17. The membrane applicator system of claim 14, further comprising:
a decoupling element coupled to the frame;
a dispenser coupled to the frame, the dispenser comprising dispensable material, a dispensed portion of the dispensable material positioned adjacent the decoupling element; and
an actuating mechanism configured to dispense the dispensable material adjacent the decoupling element;
wherein the membrane is coupled to the dispensable material and capable of an unpeeled position, a partially peeled position, and a fully peeled position.

18. A method comprising:
engaging a suction device to induce fluidic communication through a second end of a shaft of an applicator, the fluidic communication positioning a membrane on the second end of the shaft;
moving the applicator with respect to a frame;
pressing the applicator until the second end of the shaft comes into coupling engagement with a fixture to place the membrane into contact with the fixture and cover an aperture on the fixture, a first end of the shaft being in a first position relative to the applicator;
pressing the applicator with an increasing amount of force until the first end of the shaft is placed in a second position relative to the applicator to exert a predetermined amount of force substantially uniformly against a circumference of the membrane.

19. The method of claim 18, further comprising
distributing a dispensable material containing an array of membranes before engaging the suction device;
selecting the membrane from the array of membranes;
wherein engaging the suction device and positioning the membrane further includes causing the membrane to peel away from the dispensable material.

20. The method of claim 18, wherein pressing the applicator further includes positioning a contact member at a second end of the shaft, such that the contact member is compressed against the fixture as the shaft is moved to the second position, the contact member deforming into engagement with a surface of the fixture.

21. The method of claim 18, wherein moving the applicator with respect to the frame includes moving the applicator along a first axis of motion that is non-parallel to a longitudinal axis of the shaft; and pressing the applicator includes moving the applicator along a second axis of motion that is parallel to the longitudinal axis of the shaft.
